(19) United States
(12) Patent Application Publication
(10) Pub. No.: US 2013/0014324 A1
(43) Pub. Date: Jan. 17, 2013

(54) Health Care Delivery System and Components Thereof

(71) Applicants: Timothy Joseph Receveur, Guilford, IN (US); David Ribble, Indianapolis, IN (US); Jason Amrhein, Batesville, IN (US); Christopher R. O'Keefe, Batesville, IN (US); Rachel Williamson, Batesville, IN (US)

(72) Inventors: Timothy Joseph Receveur, Guilford, IN (US); David Ribble, Indianapolis, IN (US); Jason Amrhein, Batesville, IN (US); Christopher R. O'Keefe, Batesville, IN (US); Rachel Williamson, Batesville, IN (US); Stephen L. Douglas, Batesville, IN (US)

(21) Appl. No.: 13/180,929

(22) Filed: Jul. 12, 2011

(51) Int. Cl. A47C 19/00; A47C 17/00; F16L 39/00; A61G 7/10; A47C 27/00; A47C 31/00; A47C 27/08

(52) U.S. Cl. 5/400; 5/658; 5/690; 5/706; 5/715; 5/691; 285/124.1

(57) ABSTRACT

A care delivery system includes a bed (20) having a bed-side interface unit (B), an appliance set (90) comprising one or more appliances (99) and two or more appliance-side interface units (A) distributed among the appliances, and a set (124) of one or more adaptors (126) each having a host interface unit (H) compatible with the bed-side interface unit, and a client interface unit (C). Each adaptor is arranged to accommodate fluid flow between its host interface unit and its client interface unit. Each client interface unit of the adaptor set, taken individually, is compatible with at least one but fewer than all of the appliance-side interface units of the appliance set and, taken collectively, are compatible with all of the appliance-side interface units of the appliance set. The system also includes an appliance annunciator (140) and an appliance discriminator (76) responsive to the annunciator thereby configuring the system for the pneumatic demands of the appliance.

### TECHNICAL FIELD

The subject matter described herein relates to a health care delivery system and components thereof, in particular a health care delivery system including a bed, a set of one or more pneumatic appliances for the bed and/or for the care of the bed occupant, and a set of one or more adaptors for connecting the member or members of the appliance set to the bed. An annunciator and associated discriminator reveal the identity of the appliance so that a supply of air to the appliance is consistent with the specific needs of the appliance.

### BACKGROUND

Beds of the type used in hospitals, other health care facilities and home health care settings are a component of a health care delivery system. In many cases a pneumatic appliance is also a component of the system. Examples of such appliances include air mattresses, sequential compression boots, mattress toppers, chest wall oscillation devices, and turn assist bladders. Air is supplied to the appliance by a compressor that responds to commands issued by a controller. The different types of appliances have different pneumatic requirements (e.g. air pressure and flow rate) that the compressor must satisfy. Different appliances of the same type, e.g. different models of a particular type of appliance, may also have different pneumatic requirements. In the interest of simplifying system operation it is desirable for the controller to be able to automatically identify the type of appliance being used so that the system can be automatically configured for the pneumatic demands of the appliance.

### SUMMARY

A care delivery system includes a bed having a bed-side interface unit, an appliance set comprising one or more appliances and two or more appliance-side interface units distributed among the appliances, and a set of one or more adaptors each having a host interface unit compatible with the bed-side interface unit, and a client interface unit. Each adaptor is arranged to accommodate fluid flow between its host interface unit and its client interface unit. Each client interface unit of the adaptor set, taken individually, is compatible with at least one but fewer than all of the appliance-side interface units of the appliance set and, taken collectively, are compatible with all of the appliance-side interface units of the appliance set. The system also includes an appliance annunciator and an appliance discriminator responsive to the annunciator thereby configuring the system for the pneumatic demands of the appliance.

### BRIEF DESCRIPTION OF THE DRAWINGS

The foregoing and other features of the various embodiments of the health care delivery system and its components described herein will become more apparent from the following detailed description and the accompanying drawings in which:

FIG. 1 is a schematic side elevation view showing a bed, and a bed-side interface unit B.

FIG. 2 is a perspective view schematically showing an appliance set comprising at least two different types of pneumatic mattresses and a sequential compression boot, each appliance having an appliance-side interface unit A, and also showing a set of adaptors each having a host interface unit H compatible with the bed-side interface unit B and a client interface unit C compatible with an appliance-side interface unit A for connecting the appliance to the bed.

FIGS. 3A-3C are schematic perspective views similar to FIG. 2 showing alternative appliance sets and adaptor sets.

FIG. 4 is a schematic perspective view of an adaptor similar to those of FIGS. 2 and 3A-3C but having a “three by four” architecture.

FIG. 5 is a schematic perspective view of one end on an adaptor whose a host interface unit includes four ports and a portion of a bed whose bed-side interface unit includes six ports.

FIG. 6 is a schematic perspective view of an example health care delivery system comprising a bed with a single bed-side interface unit B, two appliances having appliance-side interface units A that differ from each other, and a pair of adaptors both with a host interface unit H compatible with bed-side interface unit B and each with a client interface unit C specific to one of the appliance side interface units.

FIGS. 7-13 are schematic perspective views showing alternative annunciator/discriminator pairs that cooperate with each other to reveal the identity of an appliance connected to client interface unit C.

FIG. 14 is a schematic plan view showing a bed having a bed-side interface unit, an adaptor, and a set of appliances with two of the appliances connected to a common appliance-side interface unit in parallel fluid flow relationship with each other.

FIG. 15 is a schematic plan view of an alternate adaptor for use with the bed and appliance of FIG. 14.

FIG. 16 is a schematic plan view similar to that of FIG. 14 showing two appliances connected to a common appliance-side interface unit in series fluid flow relationship with each other.

### DETAILED DESCRIPTION

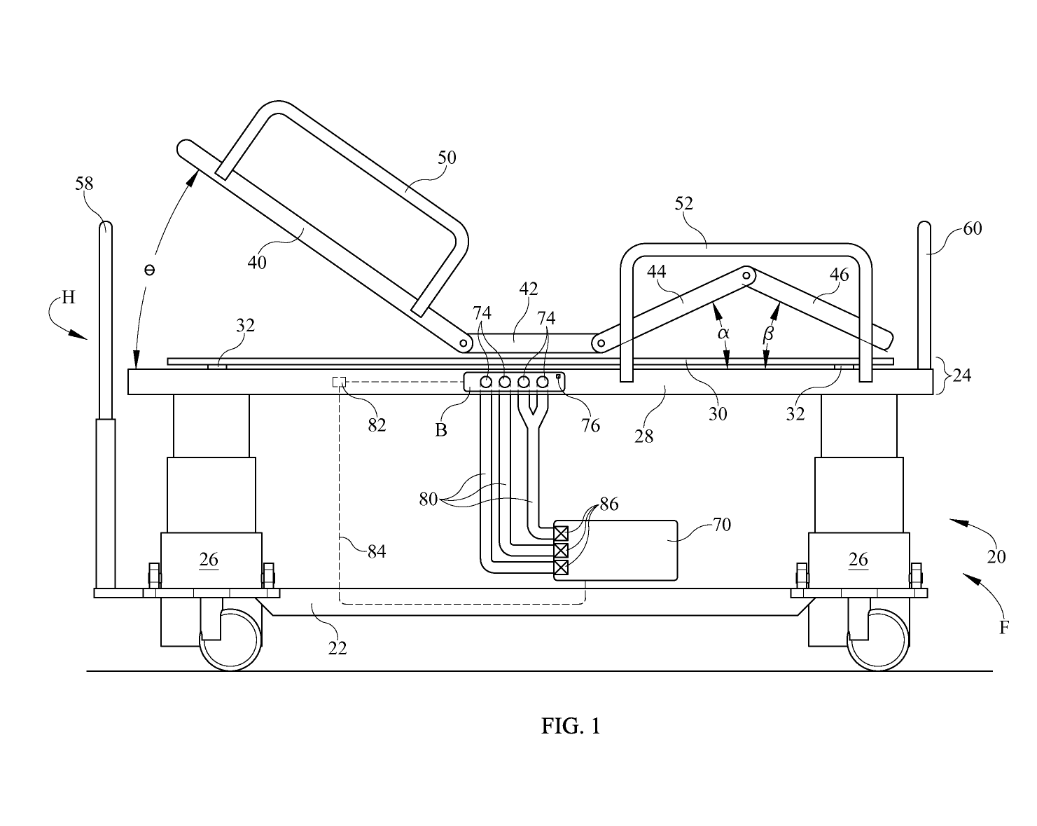

Referring to FIG. 1 a hospital bed 20, which is one component of a health care delivery system described herein, extends longitudinally from a head end H to a foot end F and laterally from a right side (visible in the plane of the illustration) to a left side. The bed includes a base frame 22 and an elevatable frame 24 connected to the base frame by head and foot end lift mechanisms, not visible, each housed inside a telescoping canister assembly 26. The elevatable frame includes at least an intermediate frame 28, and may also include a weigh frame 30 supported on the intermediate frame through load cells 32 so that the weight of a bed occupant can be monitored. The bed frame also includes a deck comprising a torso section 40, a seat section 42, a thigh section 44 and a calf section 46. Actuators, not illustrated, are operable to adjust the orientation angles θ, α, and β of the upper body, thigh and calf sections. The frame also includes left and right head end siderails 50 connected to the upper body deck section and left and right foot end siderails 52 connected to the elevatable frame. The frame also includes a headboard 58 attached to base frame 22 and a footboard 60 attached to elevatable frame 24.

The bed also includes a frame-mounted pump 70 for providing air to or evacuating air from a set of one or more appliances. A bed-side interface unit B having one or more fluid ports 74 is secured to the frame. The bed-side interface unit includes an appliance discriminator 76 described in more detail below. Air conduits 80 extend between the pump and the bed-side interface unit. A controller 82, such as a microprocessor, communicates with bed-side interface unit B or components thereof and with pump 70 or components thereof, either wirelessly or through physical communication lines 84 such as wires or optical cables. Valves 86 in pump 70 or in air conduits 80 are provided to control the flow of air through the conduits.

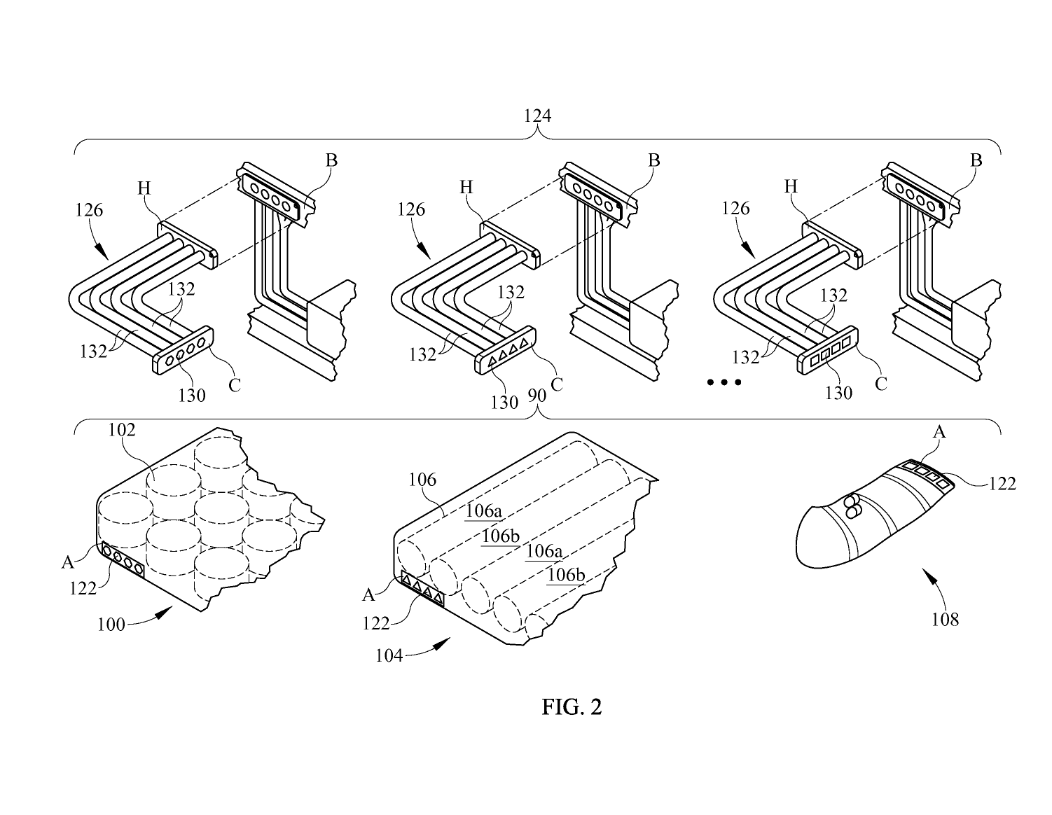

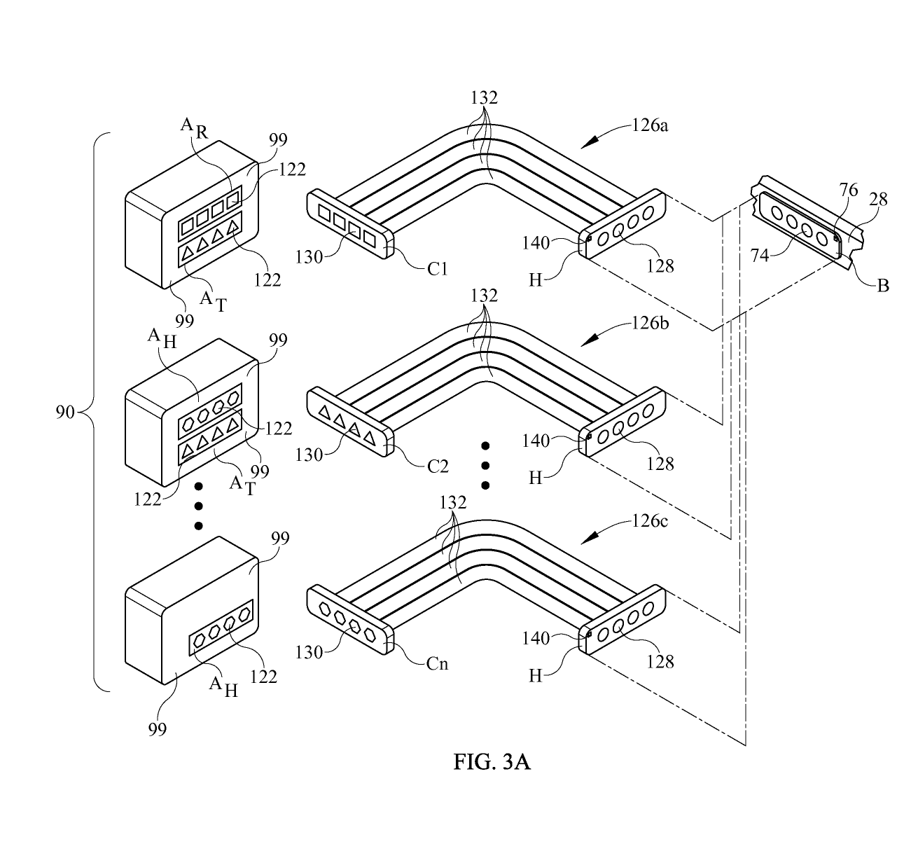

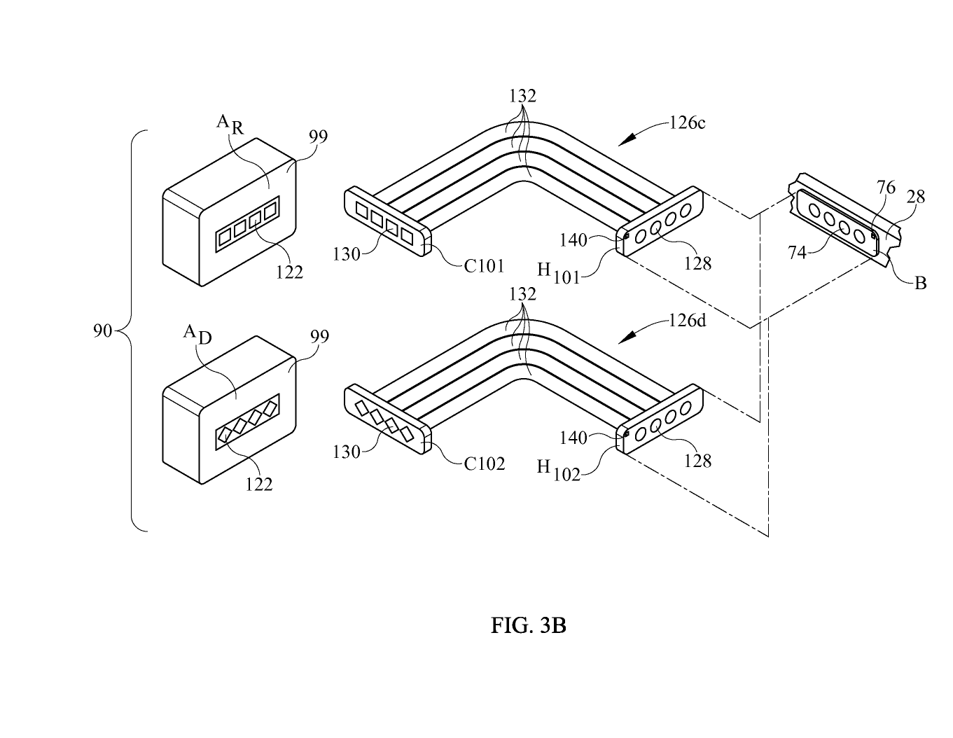

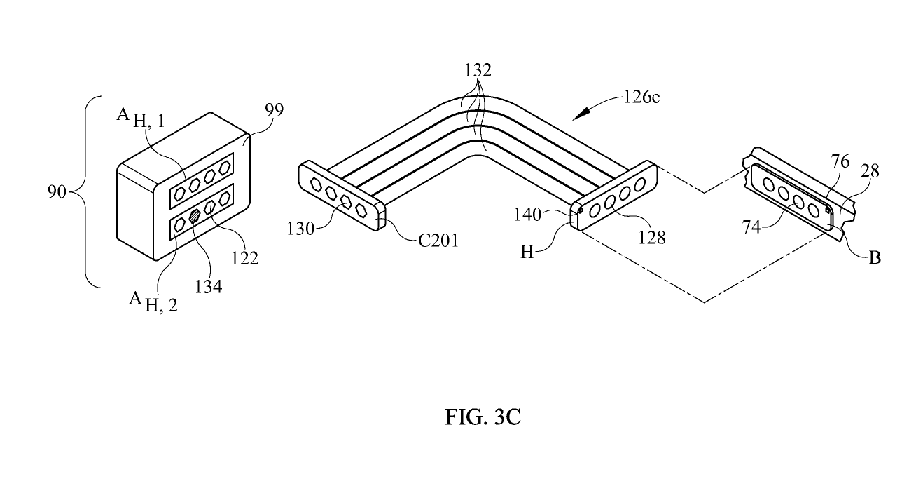

Referring to FIGS. 2 and 3A-3C, the health care delivery system also includes an appliance set 90 comprising one or more appliances, identified with appliance specific reference numerals 100, 104, 108 in FIG. 2 and with generic reference numeral 99 in FIGS. 3A-3C. Example appliances shown in FIG. 2 include a pneumatic mattress 100 whose components include vertically oriented cylindrical cells 102, a pneumatic mattress 104 whose components include horizontally oriented bladders 106, and a compression applicator 108 such as a sequential compression boot for combating deep vein thrombosis. Other example appliances include a mattress topper designed to have an airstream flowing through its interior, a chest wall oscillation device, and a turn assist bladder. These appliances, and others which may be members of appliance set 90, are supplied with air from pump 70. The pump may also be used to suction air from the appliance. In general, the pneumatic demands of the appliances (e.g. air pressure and flow rate) differ. For example some appliances, such as the pneumatic mattresses, require pressurization of cells 102 or bladders 106. Once pressurized, the cells or bladders may be left at a constant pressure for an extended time or may be subject to low frequency cyclic variations in pressure. Other appliances, such as the chest wall oscillation device, require pressure variations of considerably higher frequency. Still other appliances, such as the topper, require a continuous flow of air therethrough. In addition, different portions of a single appliance may place different demands on the air supply. For example cells 106a and 106b of mattress 104 might be pressurized cyclically between a higher pressure and a lower pressure such that the cyclic pressure variation of cells 106a is out of phase with the cyclic pressure variation of cells 106b. Moreover different appliances of a given type may have different pneumatic requirements. For example a pediatric model of a sequential compression boot may require a different pressure and cyclic frequency than are required for an adult model.

In the above described embodiment of the care delivery system the bed, by definition, does not include a mattress. As a result mattresses are eligible to be members of the described appliance set. In another embodiment of the care delivery, system, the bed includes a mattress which rests on the deck, in which case the mattress would not be a member of the appliance set. In embodiments in which the bed is defined as including a mattress, the bed-side interface unit may reside on the mattress. The following discussion is based on the embodiment in which mattresses are considered to be appliances rather than components of the bed.

As seen in FIGS. 2 and 3A-3C, the set of one or more appliances includes two or more appliance-side interface units A distributed among the appliances so that each appliance of the set includes at least one appliance-side interface unit. The appliance-side interface units are identified generally with unsubscripted reference character A and individually with subscripted reference character A. Each appliance-side interface unit includes one or more fluid ports 122. The fluid ports serve as inlets that receive air required by the appliance, for example to pressurize bladders or to establish continuous flow of air through a topper. For example, FIG. 3A shows a set of n appliances, some having multiple appliance-side interface units A and others having a single appliance side interface unit A. FIG. 3B shows a set of two appliances each having only a single appliance-side interface unit A. FIG. 3C shows a set of appliances whose membership is limited to a single appliance having two appliance side interface units A. Such an appliance could be a multi-functional appliance with each function corresponding to one of the appliance-side interface units or could be a multi-modal appliance that provides variations of a single function.

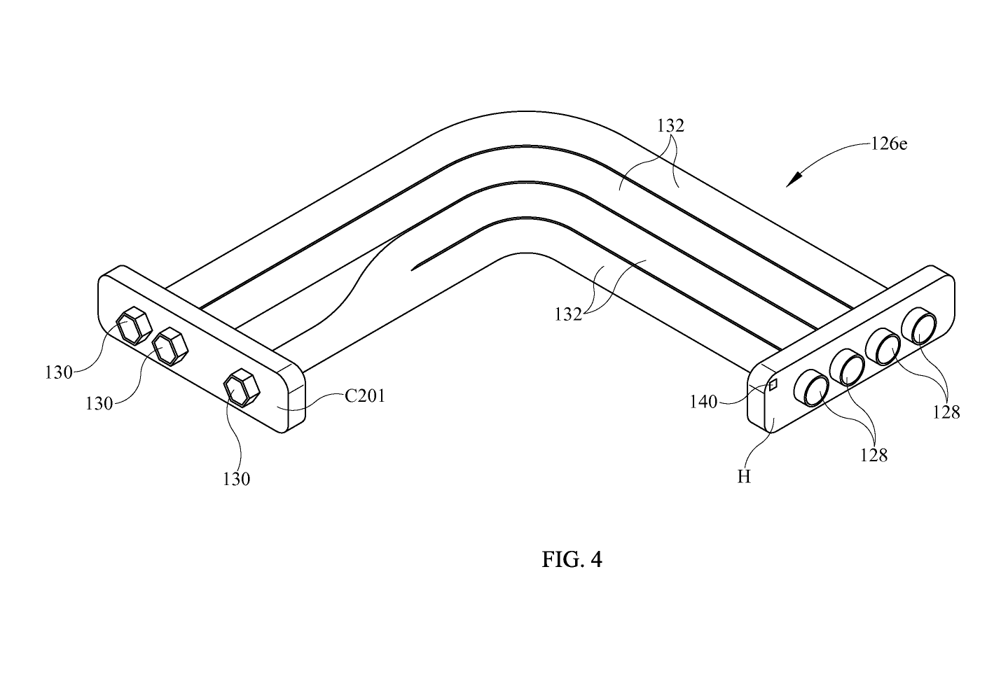

The health care delivery system also includes a set 124 of one or more adaptors 126. Each adaptor 126 comprises a single host interface unit H with one or more fluid ports 128 and a single client interface unit C also with one or more fluid ports 130, and is arranged to accommodate fluid flow between the host interface unit H and the client interface unit C. For example each adaptor illustrated in FIGS. 2 and 3A-3C includes four fluid conduits 132 each extending from a host fluid port 128 to a companion client fluid port 130. Other architectures are also contemplated, for example the “three by four” configuration of FIG. 4. Each adaptor includes an appliance annunciator 140, such as the annunciator shown on the host interface units H.

The different geometric shapes used to depict fluid ports 74, 122, 128, 130 are not intended to reflect their actual geometry, but instead are merely an illustrative technique to indicate compatibility (or lack thereof) of the bed-side interface units with the host interface units and of the appliance-side interface units with the client interface units. Subscripts R, T, H and D used herein to identify specific appliance-side interface units are simply the first letters of the illustrative shapes—rectangle, triangle, hexagon, diamond.

Host interface unit H of each adaptor is compatible with the bed-side interface unit B. As used herein, “compatible” means that the interface units can be connected to each other so that fluid can flow across the interface defined by the interface units. Typically, the ports of one interface unit will be aligned with those of the mating interface unit to facilitate such fluid flow. In addition, compatibility means that when the host interface unit H is connected to a bed-side interface unit B, annunciator 140 and discriminator 76 can cooperate with each other to reveal the identity of an appliance connected to client interface unit C. Revealing the identity of an appliance includes revealing the selected functionality of a multi-functional appliance and revealing the selected operational mode of a multi-modal appliance. The connection between mating interface units is one that can be readily made or broken by a user and that, once made, cannot be easily broken without intentional user intervention. Because bed-side interface unit B is compatible with all the host interface units H of the adaptor set, it can also be thought of and referred to as a universal interface unit.

Each client interface unit C of the set 124 of adaptors, taken individually, is compatible with at least one but fewer than all of the appliance-side interface units A of the appliance set 90 and, taken collectively, are compatible with all of the appliance-side interface units of the appliance set. For example in FIG. 3A, client interface unit C1 is compatible with appliance-side interface unit A_{R}, client interface unit C2 is compatible with appliance-side interface unit A_{T}, which is present on two of the illustrated appliances, and client interface unit Cn is compatible with appliance-side interface unit A_{H}, which is also on two of the illustrated appliances. In FIG. 3B client interface unit C101 is compatible with appliance-side interface unit A_{R} on one of the appliances, and client interface unit C102 is compatible with appliance-side interface unit A_{D} on the other appliance. In FIG. 3C client interface unit C201 is compatible with appliance-side interface units A_{H, 1} and A_{H, 2} on the single illustrated appliance. The configuration of FIG. 3C could be applicable if the appliance is multi-functional or multi-modal. For example connecting interface unit C201 to unit A_{H, 1} could be used to permit fluid flow through all four of the illustrated ports to satisfy a first fluid demand corresponding to a first mode of operation of the appliance, whereas connecting interface unit C201 to unit A_{H, 2} could be used to permit fluid flow through only three of the host ports to satisfy a second fluid demand corresponding to a second mode of operation of the appliance. In the example of FIG. 3C a plug 134 occupies the unnecessary appliance port to block fluid flow into that port even though pump 70 may be pressurizing the fluid line 80 (FIG. 1) leading to the corresponding port on the bed-side interface unit.

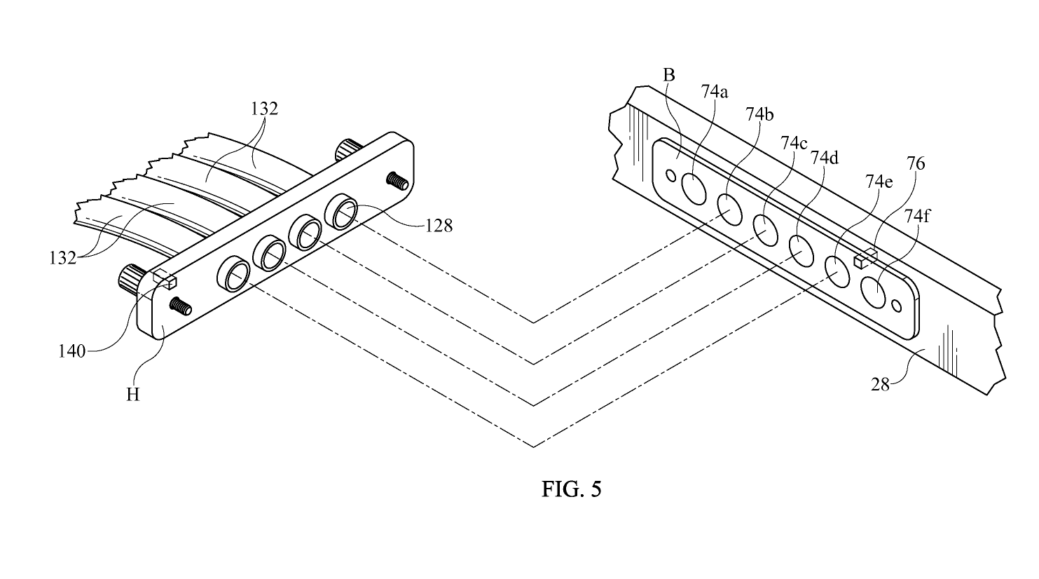

FIG. 5 shows a possible arrangement in which bed-side interface unit B has six ports but host interface unit H has only four ports. The annunciator/discriminator pair informs the controller 82 (FIG. 1) that the appliance connected to the client interface unit of the adaptor does not require fluid flow through bed-side ports 74a and 74f. As a result, the controller causes valves, such as valves 86 of FIG. 1, to close thereby blocking airflow to those ports.

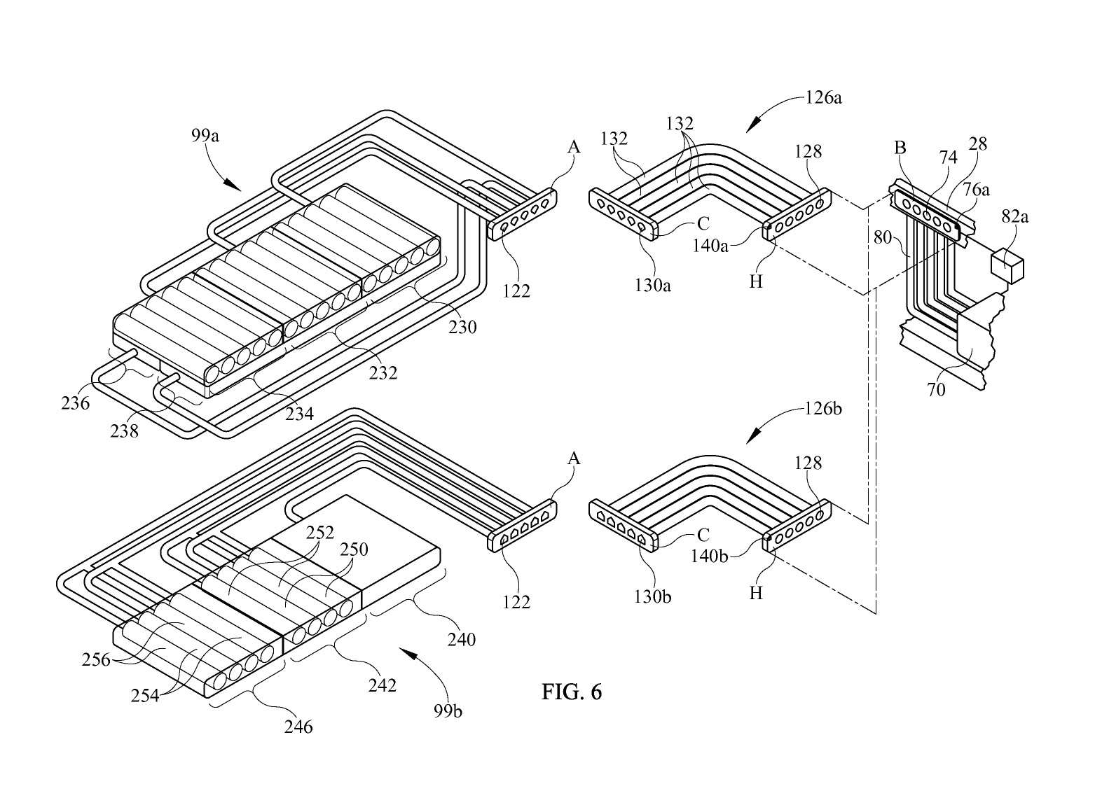

In the example of FIG. 6, appliance 99a is an occupant support comprising a mattress having a mattress head zone 230, a mattress seat zone 232, a mattress leg zone 234, a left turn assist bladder 236 and a right turn assist bladder 238. Adaptor 126a includes annunciator 140a, which cooperates with discriminator 76a to cause processor 82a to configure the system for the pneumatic demands of the occupant support, specifically the individual demands of the three mattress zones and the two turn assist bladders. Appliance 99b is an occupant support comprising a mattress head zone 240, a mattress seat zone 242, and a mattress leg zone 246. The seat zone includes longitudinally alternating first and second bladders 250, 252. The leg zone includes longitudinally alternating third and fourth bladders 254, 256. Adaptor 126b includes annunciator 140b, which cooperates with discriminator 76 to cause processor 82 to configure the system for the pneumatic demands of the occupant support, specifically the individual demands of the first, second, third and fourth bladders and of the seat and leg zones.

It should be noted that non-functional interface units (those not intended to pass fluid to a mating interface unit) do not contribute to the count of interface units. For example, a manufacturer may produce two different appliances, one with three modes of operation, each of which requires a dedicated appliance-side interface unit, and another appliance with only two modes of operation requiring only two appliance-side interface units. The manufacturer may, however, find it convenient and economical to manufacture only a single appliance housing with three interface units. When such a housing is installed on an appliance having only two modes of operation, one of the three interface units is nonfunctional.

As is evident from the foregoing, each member of the adaptor set 124 permits the bed-side interface unit B, and therefore pump 70, to be placed in fluid communication only with a pre-selected subset of the set 90 of appliance-side interface units A. For example adaptor 126c of FIG. 3B can be connected to bed-side interface unit B by way of host interface unit H101 and to appliance side interface unit A_{R} by way of client interface unit C101, to establish fluid communication between pump 70 and the appliance associated with appliance-side interface unit A_{R}. Similarly, adaptor 126d of FIG. 3B can be connected to bed-side interface unit B by way of its host interface unit H102 and to appliance side interface unit A_{D} by way of client interface unit C102 to establish fluid communication between pump 70 and the appliance associated with appliance-side interface unit A_{D}. Each adaptor 126 of FIG. 3B is therefore specific to an interface unit. In the example of FIG. 3B the mutually exclusive, collectively exhaustive distribution of the two interface units between the two appliances of the appliance set causes each adaptor to also be specific to one and only one of the appliances in the appliance set. In the examples of FIGS. 3A-3C, the distributions of the appliance-side interfaces causes each adaptor to be specific to an appliance, to a specific function of a multi-functional appliance, to a specific mode of a multi-modal appliance, or to some combination thereof.

In order to support the above described adaptor specificity, the annunciator 140 of each adaptor cooperates with discriminator 76 on the bed to define an annunciator/discriminator pair. The discriminator is responsive to the annunciator such that the annunciator/discriminator pair identifies the appliance (or functionality or mode of operation an appliance) connected to the client interface unit of the adaptor and, by doing so, configures the system for the pneumatic demands that pump 70 must satisfy. These demands include but are not limited to pressures, flow rates, cycle frequencies and destination of the supplied air. For example if the appliance in question is pneumatic mattress 104 of FIG. 2, and if it is desired to inflate bladders 106 according to a first mode of operation (e.g. inflate all bladders to a single target pressure and maintain the pressure) the use of a particular adaptor 126 selected from the adaptor set would be used to configure the system for the pneumatic demands that must be satisfied. Specifically, controller 82 receives signals generated by the annunciator/discriminator pair. The signals reveal the identity of the appliance (or equivalently, the function of a multi-functional appliance, or operational mode of a multi-modal appliance) connected to the client interface unit of the adaptor. As a result, the processor operates the pump 70, valves 86 and any other related components to deliver air to the appliance in accordance with the pneumatic demands (e.g. target pressure, fill rate) of bladders 106a, 106b. If instead it is desired to operate bladders 106 according to a second mode of operation (e.g. cycle the pressure in the “a” and “b” bladders out of phase with each other) the use of a different adaptor from the adaptor set could be used to signal the processor to operate the pump, valves and other components in accordance with the pneumatic demands of cyclic operation.

Several examples of annunciator/discriminator pairs are described in the following paragraphs.

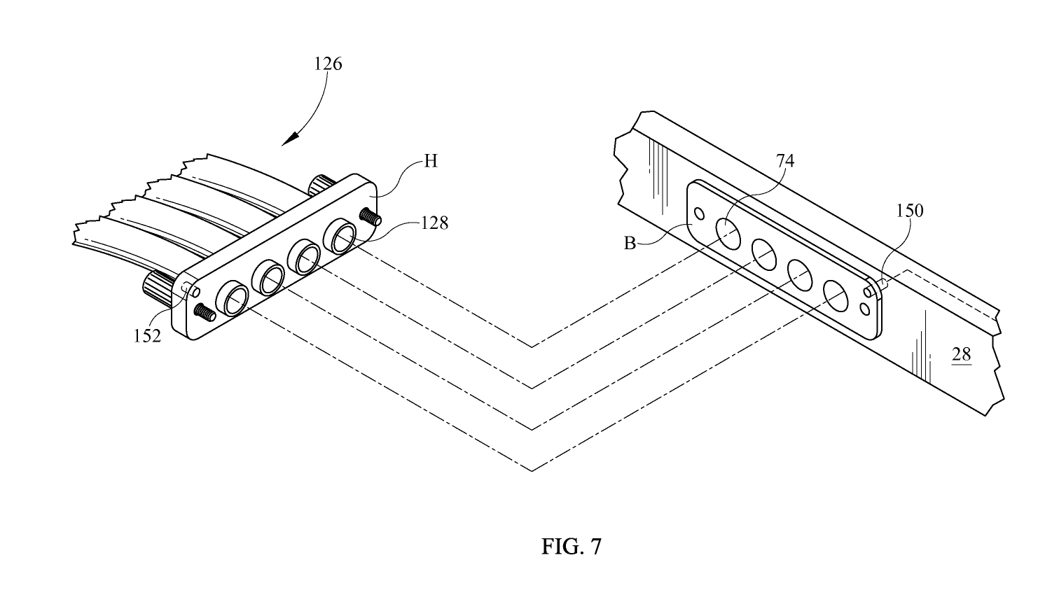

FIG. 7 shows an RFID pair comprising a bed mounted RFID transceiver 150 and an adaptor mounted RFID tag 152 having an electrical circuit which, when excited by the transceiver, responds in a circuit specific way thereby identifying the appliance to which the client interface unit of the adaptor is connected.

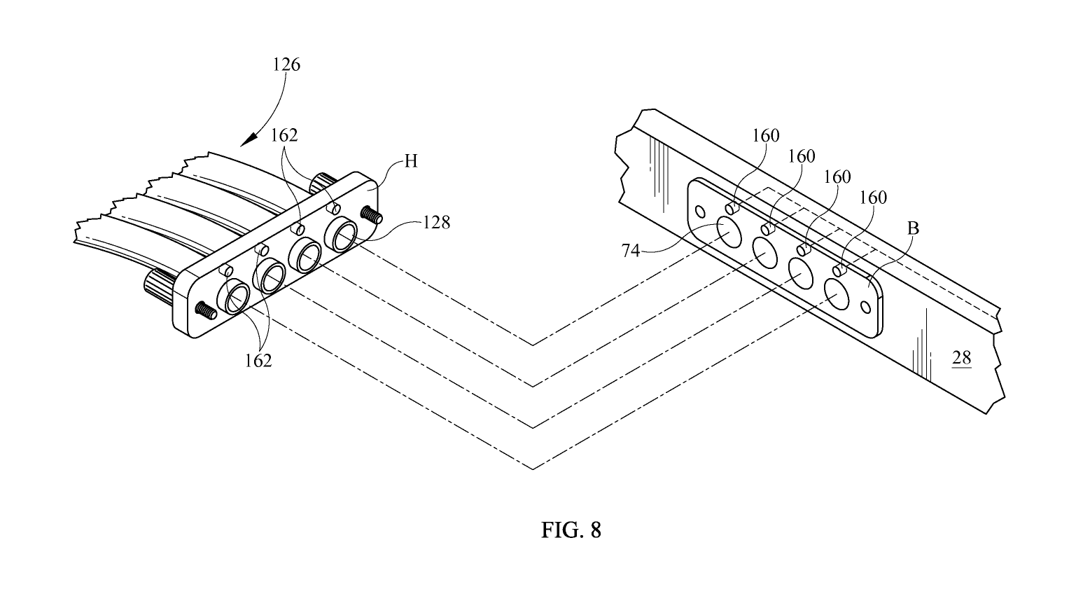

FIG. 8 shows a Hall effect pair comprising excitation sources 160 and sensors 162 which, when excited by an excitation source, identify the appliance to which the client interface unit of the adaptor is connected.

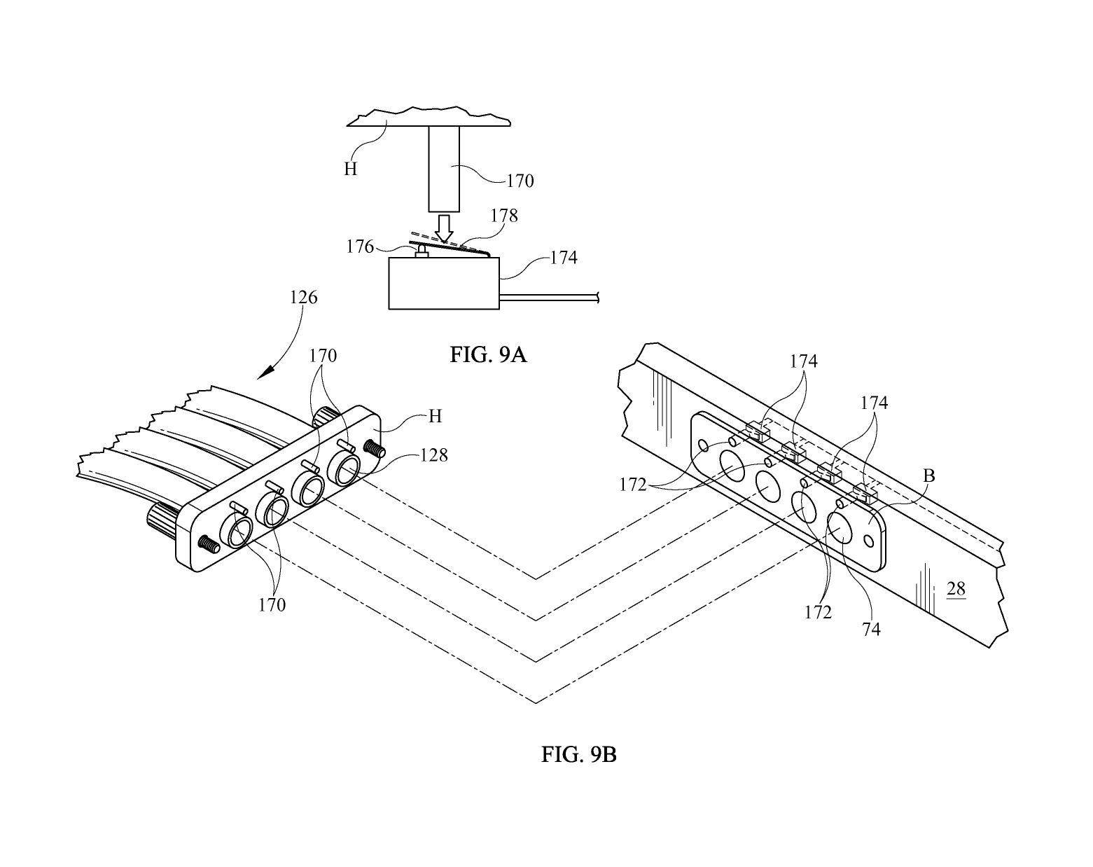

FIGS. 9A-9B show an electro-mechanical switch. Prongs 170 extend from a representative host interface unit H. Corresponding sockets 172 on a representative bed-side interface unit B are each aligned with a switch 174 having a fixed terminal 176 and a moveable terminal 178. Connecting the interface units to each other causes the prongs to serve as actuators, thereby urging moveable terminal 178 into contact with fixed terminal 176 to indicate the identity of the appliance connected to the client interface unit of the adaptor.

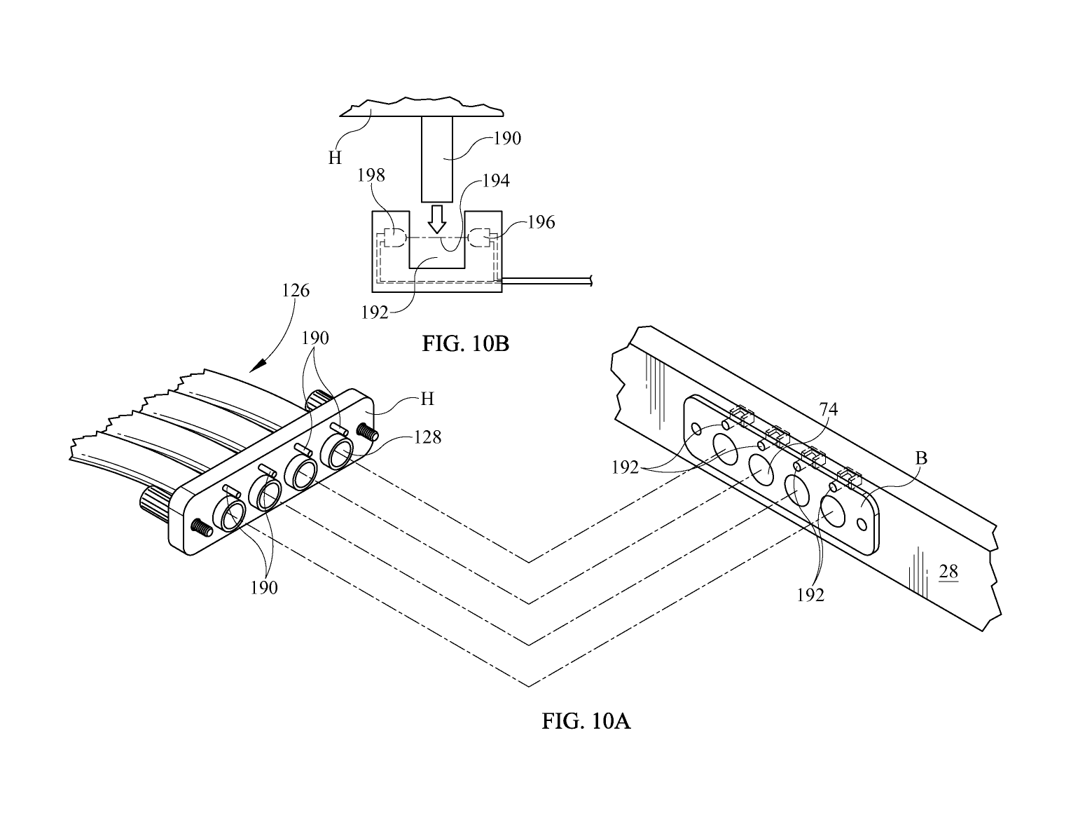

FIGS. 10A-10B show a non-contact switch. Prongs 190 extend from a representative host interface unit H. Corresponding sockets 192 on a representative bed-side interface unit B are each traversed by an optical or other suitable electromagnetic signal 194 emitted by, for example, a light emitting diode 196 and received by a photodiode 198. Connecting the interface units to each other causes the prongs to serve as an actuator for interrupting the signal thereby indicating the identity of the appliance connected to the client interface unit of the adaptor.

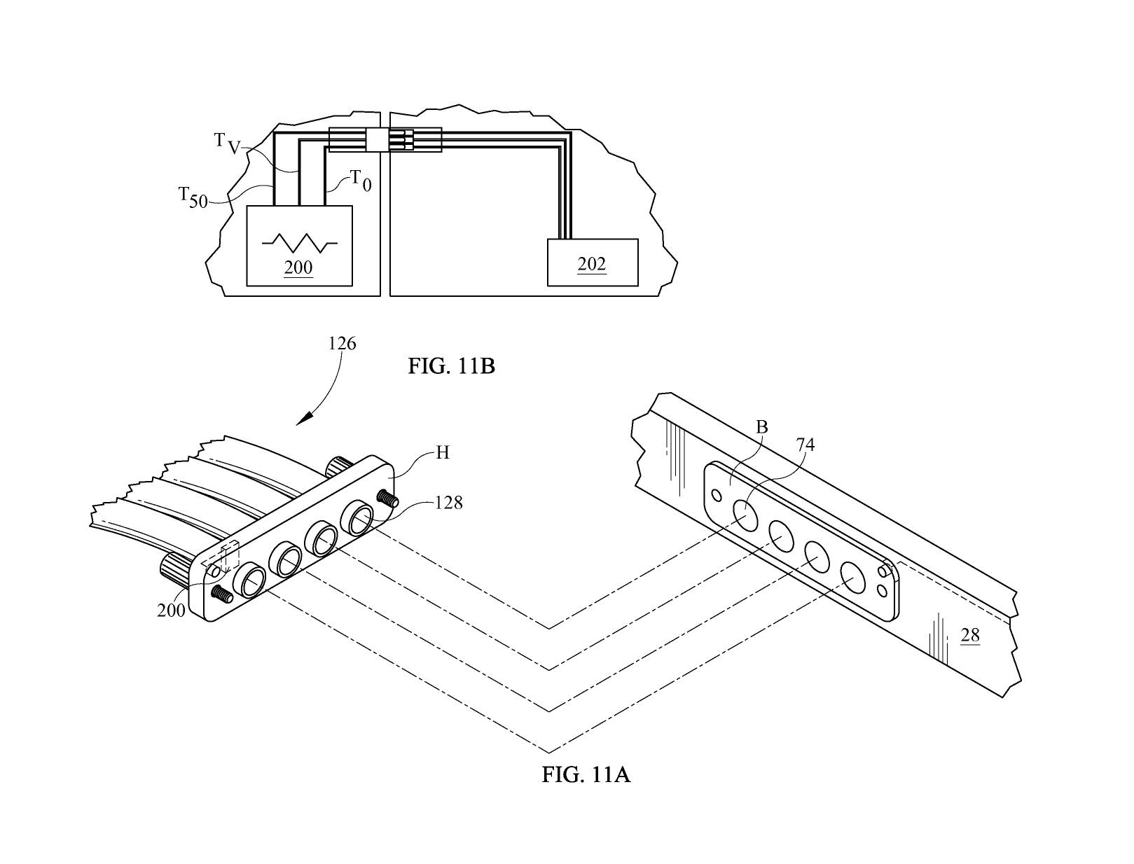

FIGS. 11A-11B show an annunciator 140 in the form of a resistive circuit 200 and a discriminator in the form of a microprocessor 202. The voltage drop across terminals T₅₀ and Tᵥ is a function of the resistance of the circuit and therefore indicates the identity of the appliance connected to the client interface unit of the adaptor.

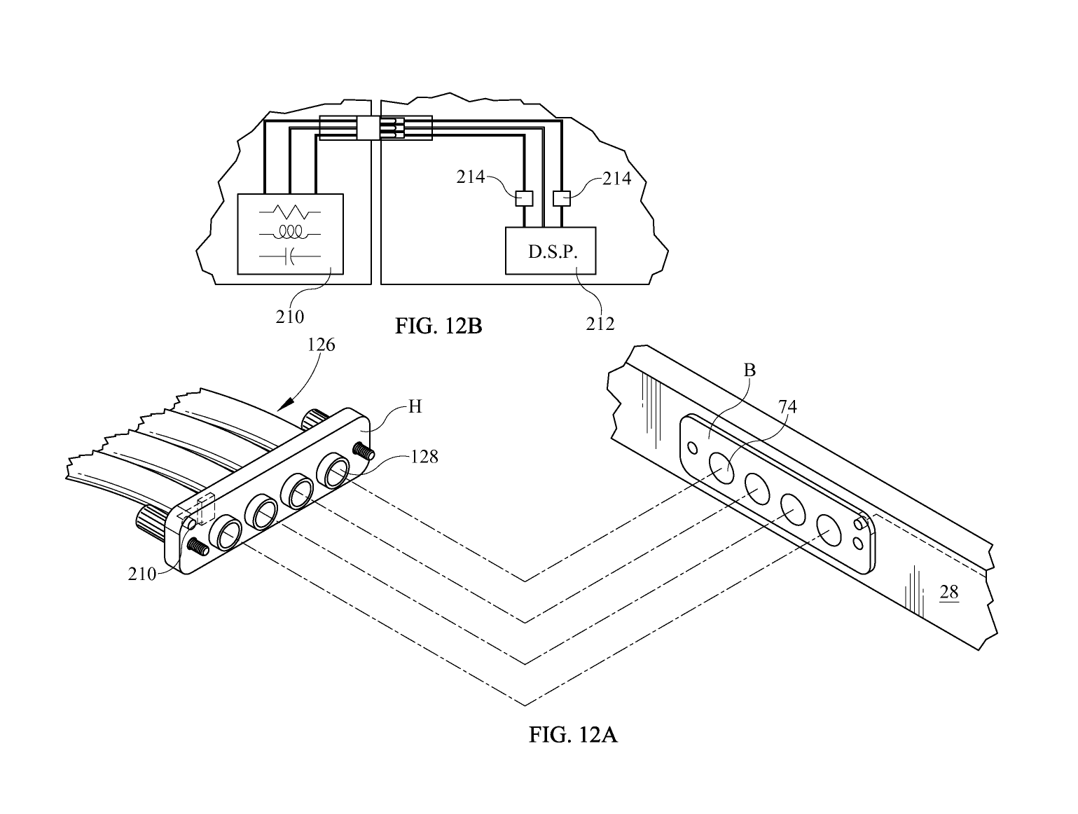

FIGS. 12A-12B show an annunciator 140 in the form of an RLC circuit 210 and a discriminator 76 in the form of a microprocessor such as a digital signal processor (DSP) 212. The communication paths between DSP 212 and circuit 210 include appropriate signal conditioners 214. The DSP applies a known perturbation to the circuit, causing a circuit response which is characteristic of the circuit parameters (resistance, inductance and capacitance) and therefore indicates the identity of the appliance connected to the client interface unit.

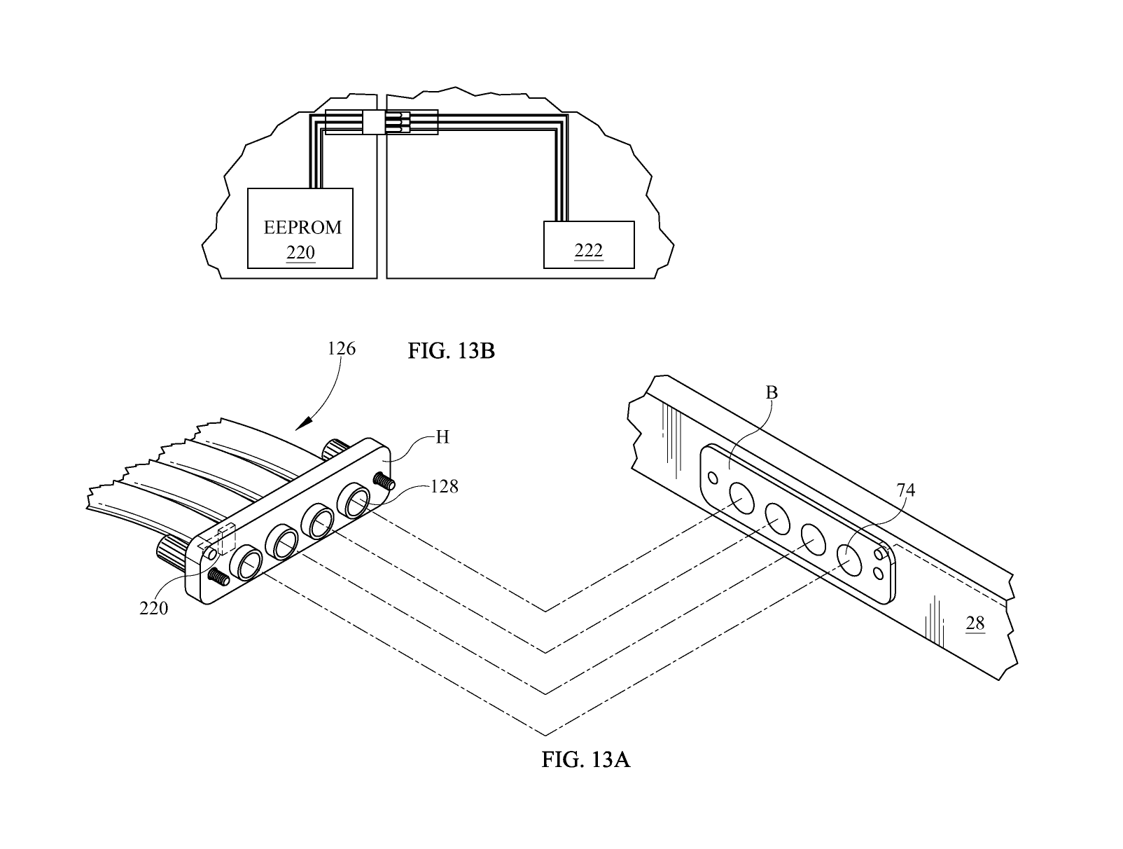

FIGS. 13A-13B show an annunciator in the form of an electrically eraseable read only memory (E²PROM) 220 or other form of read only memory (ROM) and a discriminator 76 in the form of a microprocessor 222. Memory 220 includes information readable by processor 222 to identify the appliance to which the client interface unit of the adaptor is connected.

In FIGS. 7-13 annunciator 140 is a component of host interface unit H and discriminator 76 is a component of bed-side interface unit B. Certain technologies, such as mechanical switches, optical switches and, to some extent, RFID and Hall effect pairs, rely on the close proximity between the annunciator and discriminator achieved when the interface units are connected to each other. Other technologies, possibly including the RFID pair and Hall effect pair may be more tolerant of some degree of remoteness between the annunciator and discriminator. As a result it may be possible to place the RFID transceiver elsewhere on the bed frame and/or place the RFID tag elsewhere on the adaptor. Similarly it may be possible to place the Hall effect excitation source elsewhere on the bed frame and/or place the Hall effect sensor elsewhere on the adaptor. Still other technologies, such as the circuit/processor pairs of FIGS. 11-12 and the memory/processor pair of FIG. 13, may operate satisfactorily even if the annunciator member of the pair and the discriminator member of the pair are widely separated from each other.

At least some of the above described technologies can also be used to identify appliances by way of a binary code. Using the Hall effect pair as an example, an array of m excitation sources and m sensors could be used to establish a binary code having 2^{m} states, each state corresponding to a particular appliance, functionality or mode of operation. As a practical matter, one of the states would correspond to “no appliance installed”.

Referring again to FIGS. 1 and 3A-3C, bed 20 is one constituent of the above described health care delivery system. The bed comprises a bed frame 24 including a bed-side universal interface unit B mounted thereon. Alternatively, interface unit B can be mounted elsewhere on the bed, including on a mattress in embodiments in which the bed includes a mattress. The bed-side interface unit has one or more fluid ports 74. The bed also includes a client discriminator 76 mounted on the universal interface unit. The bed-side interface unit H is compatible with every host interface unit of a set 124 of one or more adaptors 126, each of which has a client interface unit C compatible with all of at least two appliance-side or client-side interface units A distributed among at least one appliance 99. As seen best in FIG. 3B, the quantity of adaptors is in one to one correspondence with the set of client-side interface units. Although the example embodiments described herein employ a single bed-side interface unit, a given bed can have multiple such interface units each of which is compatible with every host interface unit of a set 124 of one or more adaptors 126, each of which has a client interface unit C compatible with all of at least two appliance-side or client-side interface units A distributed among at least one appliance 99.

An appliance set 90 is also a constituent of the above described health care delivery system. The appliance set includes at least one appliance member and two or more appliance-side interface units A distributed among the members of the appliance set. Each appliance-side interface unit has one or more fluid ports 122. Each appliance-side interface unit is compatible with at least one but fewer than all of a set of client interface units C distributed among a set of at least one adaptor 126. The appliance-side interface units of the set, taken collectively, are compatible with all the client interface units of the adaptor set. Each adaptor of the set also has a host interface unit H compatible with one and only one of a given to one or more bed-side interface units on a bed. The quantity of fluid ports 122 on the appliance-side interface unit A and the quantity of fluid ports 130 on the client interface C unit may be equal to each other as seen, for example, in FIGS. 3A-3C or may be unequal to each other as seen in FIGS. 4-5. For embodiments in which the bed, by definition, does not include a mattress the members of the appliance set may include a pneumatic mattress, a pneumatic component of a mattress, a topper, a compression applicator, a chest wall oscillation device, and a turn assist bladder. For embodiments in which the bed includes a mattress, the mattress would not be eligible to be a member of the appliance set.

An adaptor set 124 is also a constituent of the above described health care delivery system. Each member of the adaptor set includes a single host interface unit H and a single client interface unit C. An annunciator 140 resides on each adaptor, for example on the host interface unit of the adaptor. Each adaptor is arranged to accommodate fluid flow between its host interface unit and its client interface unit, e.g. by way of conduits 132. The host interface units of all members of the adaptor set are compatible with a given bed interface unit on a bed. The client interface units of the adaptor set, taken individually, each are compatible with at least one but fewer than all of a set of appliance interface units distributed among a set of one or more appliances. Taken collectively, the client interface units of the adaptor set are compatible with all of the appliance interface units of the appliance set. The appliances with which the client interface units are compatible may include a pneumatic mattress, a pneumatic component of a mattress, a topper, a compression applicator, a chest wall oscillation device, and a turn assist bladder.

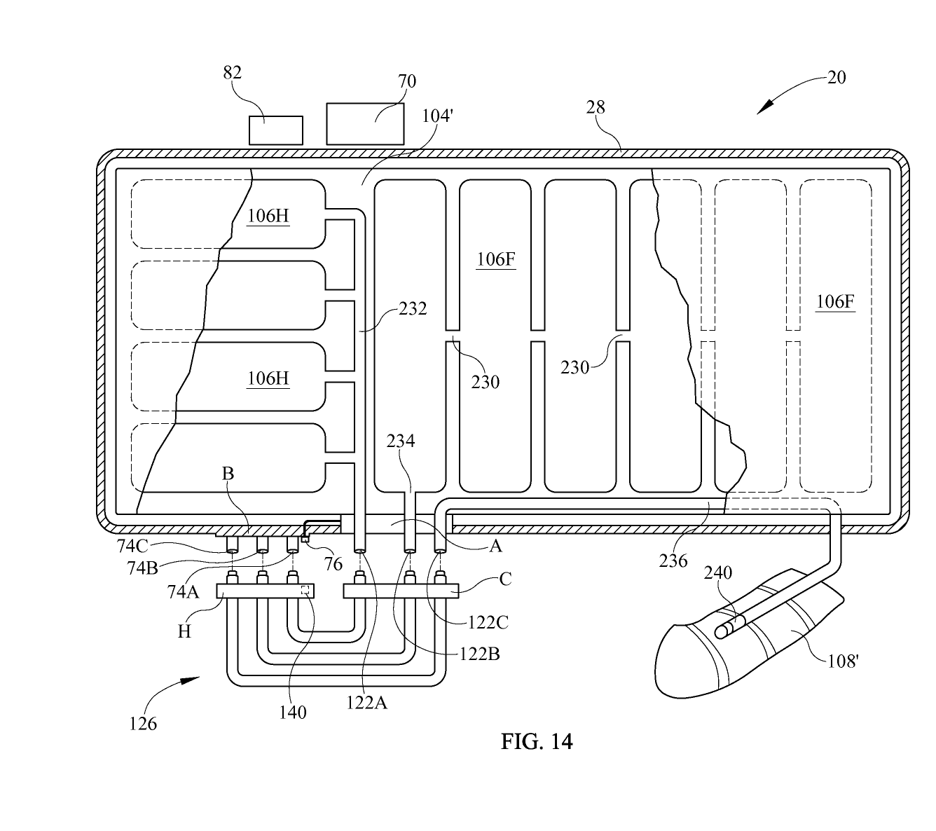

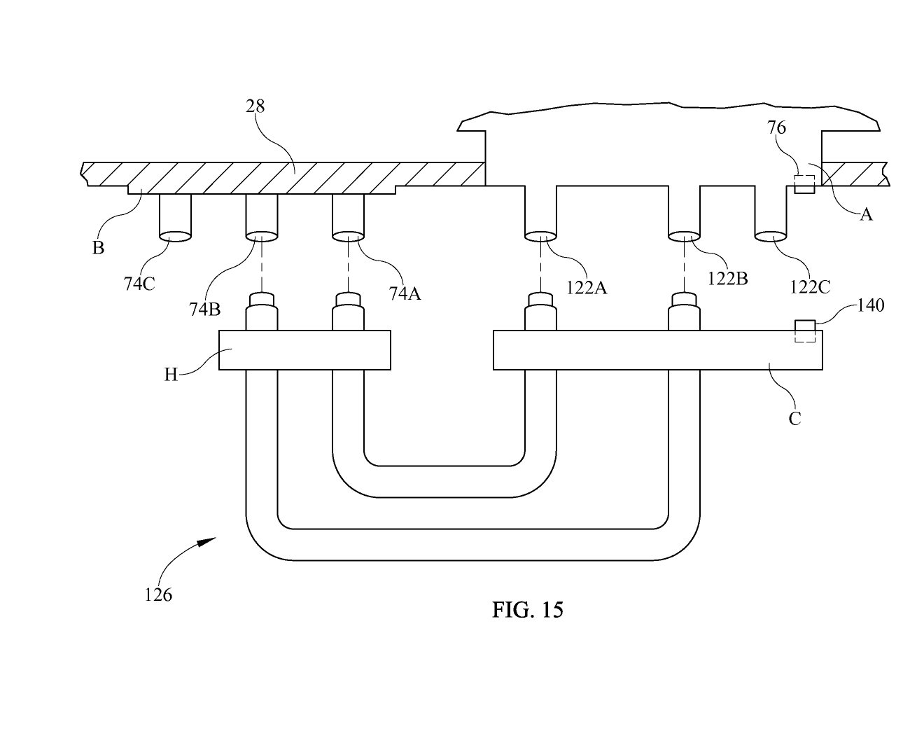

FIG. 14 illustrates a variant of the care delivery system comprising a bed 20 having a bed-side interface unit B with three ports 74A, 74B, 74C. The care delivery system also includes an adaptor set including adaptor 126 having host and client interface units H, C. The host interface unit is compatible with the bed-side interface unit. The care delivery system also includes an appliance set comprising two or more appliances. In the illustrated embodiment the appliances are an array of head end mattress bladders 106H distributed laterally across the head end of the bed, an array of foot end mattress bladders 106F distributed from the foot end of the bed to the array of head end bladders, and a sequential compression boot 108′ coupled to the foot end bladder array. The head end and foot end bladders taken together define a mattress 104′. Interbladder conduits 230 connect adjacent foot end bladders to each other. Each client interface unit C of the adaptor set is compatible with a common appliance side interface unit A having three ports 122A, 122B, 122C serving the three appliances. Port 122A communicates with an intra-mattress manifold 232 connected to each of the head end bladders. Port 122B communicates with an inlet 234 to one of the foot end bladders. Port 122C communicates with a tube 236 whose remote end is coupled by coupling 240 to the sequential compression boot 108′. The annunciator 140 and discriminator 76 reveal to controller 82 that the pneumatic demand to be satisfied by pump 70 includes the demands of the head end and foot end bladders as well as the demands of the boot so that the controller can issue commands to appropriately regulate fluid flow to the two sets of bladders and the boot component. Although the appliance side interface unit resides on the mattress 104′, air flowing from pump 70 through ports 74C and 122C flows through tube 236 to serve boot 108′ but does not service the mattress bladders 106H, 106F. Air flowing from pump 70 through ports 74B and 122B serves bladders 106F. Air flowing from pump 70 through ports 74A and 122A serves bladders 106H. If the bed occupant doesn't require the boot, a different adaptor from the adaptor set, such the adaptor of FIG. 15, can be used. The annunciator 140 associated with the adaptor of FIG. 15 would cooperate with discriminator 76 to signal the controller not to supply air through ports 74C and 122C.

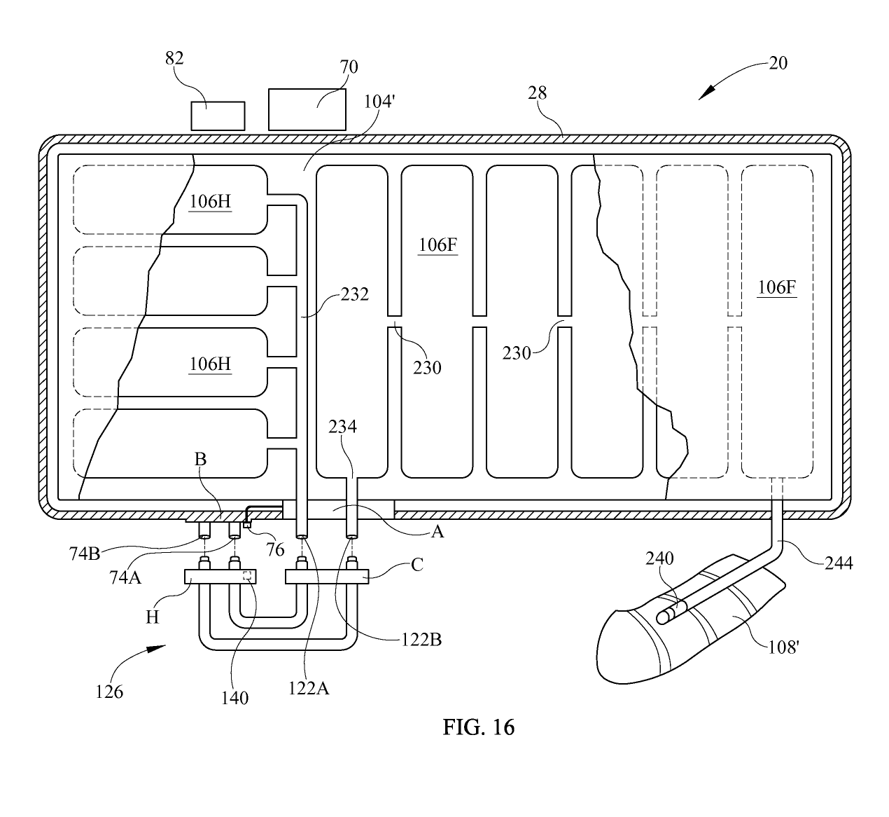

FIG. 16 illustrates another variant of the care delivery system comprising a bed 20 having a bed-side interface unit B with two ports 74A, 74B. The care delivery system also includes an adaptor set including adaptor 126 having host and client interface units H, C. The host interface unit is compatible with the bed-side interface unit. The care delivery system also includes an appliance set comprising two or more appliances. In the illustrated embodiment the appliances are an array of head end mattress bladders 106H distributed laterally across the head end of the bed, and an array of foot end mattress bladders 106F coupled to a sequential compression boot 108′. The head end and foot end bladders taken together define a mattress 104′. Interbladder conduits 230 connect adjacent foot end bladders to each other. Each client interface unit C of the adaptor set is compatible with a common appliance side interface unit A with two ports 122A, 122B serving the two appliances. Port 122A communicates with an intra-mattress manifold 232 connected to each of the head end bladders. Port 122B communicates with an inlet conduit 234 to one of the foot end bladders. An outlet conduit 244 extends from one of the foot end bladders and is coupled by coupling 240 to the sequential compression boot 108′. As a result the foot end bladder 106F and boot 108′ are in series fluid flow relationship with each other. The annunciator 140 and discriminator 76 reveal to controller 82 that the pneumatic demand to be satisfied by pump 70 includes the demands of the head end bladders 106H as well as the combined demands of the foot end bladders 106F and boot 108′ so that the controller can issue commands to appropriately regulate fluid flow to bladders 106H, 106F and boot 108′.

Although this disclosure refers to specific embodiments, it will be understood by those skilled in the art that various changes in form and detail may be made without departing from the subject matter set forth in the accompanying claims.

We claim:

1. A care delivery system comprising:
a bed including a bed frame and a bed-side universal interface unit having one or more fluid ports;
an appliance set comprising one or more appliances and two or more appliance-side interface units distributed among the one or more appliances so that each appliance includes at least one appliance-side interface unit, each appliance-side interface unit including one or more fluid ports;
a set of one or more adaptors each adaptor comprising a single host interface unit compatible with the universal interface unit, and a single client interface unit, each adaptor being arranged to accommodate fluid flow between its host interface unit and its client interface unit, wherein each client interface units of the set of adaptors, taken individually, is compatible with at least one but fewer than all of the appliance-side interface units of the appliance set and, the client interface units of the set of adaptors, taken collectively, are compatible with all of the appliance-side interface units of the appliance set;
an appliance annunciator; and
an appliance discriminator responsive to the annunciator thereby configuring the system for pneumatic demands required to be satisfied.

2. The care delivery system of claim 1 wherein the appliance annunciator is a component of the adaptor.

3. The care delivery system of claim 1 wherein the appliance annunciator is a component of the appliance.

4. The care delivery system of claim 1 wherein the universal interface unit is a component of the bed frame.

5. The care delivery system of claim 1 wherein the bed includes a mattress and the universal interface unit is a component of the mattress.

6. The care delivery system of claim 1 wherein the appliance discriminator is a component of the universal interface unit.

7. The care delivery system of claim 1 wherein the appliances comprising the appliance set are selected from the group consisting of a pneumatic mattress, a pneumatic component of a mattress, a topper, a compression applicator, a chest wall oscillation device, and a turn assist bladder.

8. The care delivery system of claim 1 wherein the discriminator and annunciator are selected from the group consisting of an RFID pair, a Hall effect pair, a switch/actuator pair, a circuit/processor pair and a memory/processor pair.

9. A bed comprising:
a bed frame;
a bed-side interface unit having one or more fluid ports;
a client discriminator;
wherein the bed-side interface unit is compatible with every host interface unit of a set of one or more adaptors, each adaptor having client interface unit compatible with all of at least two appliance interface units distributed among at least one appliance.

10. The bed of claim 9 wherein the bed-side interface units is a component of the bed frame.

11. The bed of claim 9 including a mattress and wherein the bed-side interface units is a component of the mattress.

12. The bed of claim 9 wherein the client discriminator is a component of the universal interface unit.

13. A care delivery appliance, the appliance being a member of an appliance set having at least one member and two or more appliance-side interface units distributed among the members of the appliance set, each appliance-side interface unit having one or more fluid ports and being compatible with at least one but fewer than all of a set of client interface units distributed among a set of at least one adaptor, the appliance-side interface units, taken collectively, being compatible with all the client interface units of the adaptor set, each adaptor also having a host interface unit connectably compatible with one and only one a given of one or more bed-side interface units on a bed.

14. The bed of claim 13 wherein the quantity of fluid ports on the appliance-side interface unit and the quantity of fluid ports on the client interface unit are equal to each other.

15. The care delivery appliance of claim 13 wherein the members of the appliance set are selected from the group consisting of a pneumatic mattress, a pneumatic component of a mattress, a topper, a compression applicator, a chest wall oscillation device, and a turn assist bladder.

16. The care delivery appliance of claim 13 including an appliance identity annunciator.

17. An adaptor of a set of adaptors each having a single host interface unit and a single client interface unit, each adaptor being arranged to accommodate fluid flow between its host interface unit and its client interface unit, the host interface units of all members of the adaptor set being compatible with a given bed interface unit and the client interface units of the adaptor set, taken individually, each being compatible with at least one but fewer than all of a set of appliance interface units distributed among a set of one or more appliances and, taken collectively, being compatible with all of the appliance interface units of the appliance set.

18. The adaptor of claim 17 wherein the appliances comprising the appliance set are selected from the group consisting of a pneumatic mattress, a pneumatic component of a mattress, a topper, a compression applicator, a chest wall oscillation device, and a turn assist bladder.

19. The adaptor of claim 17 including an appliance identity annunciator.

20. A care delivery system comprising:
a bed including a bed frame and a bed-side universal interface unit having one or more fluid ports;
an appliance set comprising two or more appliances and a common appliance-side interface unit serving the two or more appliances, each appliance-side interface unit including one or more fluid ports;
a set of one or more adaptors each adaptor comprising a single host interface unit compatible with the universal interface unit, and a single client interface unit, each adaptor being arranged to accommodate fluid flow between its host interface unit and its client interface unit, wherein each client interface unit is compatible with the common appliance-side interface unit;
an appliance annunciator; and
an appliance discriminator responsive to the annunciator thereby configuring the system for pneumatic demands required to be satisfied.

21. The care delivery system of claim 20 wherein at least two of the appliances are connected to the client interface unit in parallel fluid flow relationship with each other.

22. The care delivery system of claim 20 wherein at least two of the appliances are connected to the client interface unit in series fluid flow relationship with each other.
